(19) United States
(12) Patent Application Publication
(10) Pub. No.: US 2015/0010789 A1
(43) Pub. Date: Jan. 8, 2015

(54) Battery Module, Power Supply Apparatus Comprising Battery Module, and Method for Managing Temperature of Battery Module

(71) Applicant: Kabushiki Kaisha Toshiba, Tokyo (JP)

(72) Inventors: Ryosuke YAGI, Yokohama-shi (JP); Norihiro Tomimatsu, Tokyo (JP)

(21) Appl. No.: 14/323,543

(22) Filed: Jul. 3, 2014

(30) Foreign Application Priority Data
Jul. 8, 2013 (JP) 2013-142495

(51) Int. Cl. H01M 10/659; H01M 10/63

(52) U.S. Cl. CPC H01M 10/5089; H01M 10/502
USPC 429/50; 429/120; 429/62

(57) ABSTRACT

According to one embodiment, a battery module comprises a secondary battery, a heat storage pack, and a nucleation mechanism. The heat storage pack comprises a heat storage material that exchanges heat with the secondary battery. The heat storage material is able to be set to a supercooled state. The heat storage pack is arranged in contact with the secondary battery. The nucleation mechanism nucleates the heat storage material in the supercooled state.

### CROSS-REFERENCE TO RELATED APPLICATIONS

This application is based upon and claims the benefit of priority from Japanese Patent Applications No. 2013-142495, filed Jul. 8, 2013; the entire contents of which are incorporated herein by reference.

### FIELD

Embodiments described herein relate generally to a battery module comprising a secondary battery, a power supply apparatus comprising the battery module, and a method for managing the temperature of the secondary battery of the battery module.

### BACKGROUND

A heat storage material comprising a phase change material is referred to as a latent heat storage material. The latent heat storage material absorbs latent heat upon changing from a solid to a liquid, and in contrast, releases heat upon changing from a liquid to a solid.

A technique has been proposed in which the latent heat storage material is arranged in thermal connection with a secondary battery to allow the latent heat storage material to absorb heat generated by the secondary battery. According to this proposal, when the temperature of the secondary battery is higher than the temperature of the latent heat storage material, the heat in the secondary battery is absorbed by the latent heat storage material. In contrast, when the temperature of the secondary battery is lower than the temperature of the latent heat storage material, the heat in the latent heat storage material is provided to the secondary battery.

When the temperature of the secondary battery is lower than the lower limit value of a guaranteed temperature, the secondary battery shows degraded performance. In other words, it is known that the secondary battery has poor starting ability at low temperatures. This problem can be solved by using the above-described latent heat storage material.

In other words, heat generated by the secondary battery during charging or discharging (during operation) is absorbed by the latent heat storage material. Thus, after the secondary battery stops operating, the secondary battery can be kept warm by the heat in the latent heat storage material. In this state, when the charging or discharging of the secondary battery is started, performance degradation of the secondary battery can be controlled even in a low temperature environment.

However, it is possible that the secondary battery is not charged or discharged for a long time and is left in a low temperature environment. For example, in a cold area, when the secondary battery is charged or discharged in the daytime and is not used until the next morning, heat is released from the latent heat storage material to the low temperature environment. In other words, it is difficult to retain the heat in the secondary battery for a long time using the latent heat storage material as a heat source.

This problem can be solved by thermally insulating the latent heat storage material from the surrounding environment. However, the secondary battery with such heat insulation means may have its battery temperature excessively raised when repeatedly charged and discharged in a high temperature environment. When the temperature of the secondary battery is higher than the upper limit value of the guaranteed temperature, materials that the secondary battery is comprised of are thermally degraded. In other words, the secondary battery with the heat insulation means, when placed in a high temperature environment, has degraded durability and reliability.

As described above, when a means for thermally insulating the secondary battery is provided in order to improve the secondary battery's ability to start in the low temperature environment, the reliability of the secondary battery is degraded as the secondary battery is operated in the high temperature environment.

Well-known related documents include, for example, Jpn. Pat. Appln. KOKAI Publication No. 9-259938 (Patent Literature 1), Jpn. Pat. Appln. KOKAI Publication No. 2002-291670 (Patent Literature 2), and Jpn. Pat. Appln. KOKAI Publication No. 2006-329089 (Patent Literature 3).

### BRIEF DESCRIPTION OF THE DRAWINGS

FIG. 1 is a schematic diagram of a power supply apparatus with a battery module according to a first embodiment;

FIG. 2 is a cross-sectional view showing a heat storage pack provided in the battery module according to the first embodiment along with a nucleation mechanism;

FIG. 3 is a cross-sectional view showing a heat storage pack provided in the battery module according to the first embodiment along with another nucleation mechanism;

FIG. 4 is a flowchart showing a procedure for managing the temperature of a secondary battery provided in the battery module of the power supply apparatus in FIG. 1;

FIG. 5 is a flowchart showing a procedure for managing the temperature of a secondary battery provided in a battery module of a power supply apparatus according to a second embodiment;

FIG. 6 is a cross-sectional view showing a power supply apparatus according to a third embodiment;

FIG. 7 is a cross-sectional view showing a battery module taken along line F7-F7 in FIG. 6; and

FIG. 8 is a cross-sectional view showing a battery module of a power supply apparatus according to a fourth embodiment.

### DETAILED DESCRIPTION

According to one embodiment, a battery module comprises a secondary battery, a heat storage pack, and a nucleation mechanism. The heat storage pack comprises a heat storage material that exchanges heat with the secondary battery. The heat storage material is able to be set to a supercooled state. The heat storage pack is arranged in contact with the secondary battery. The nucleation mechanism nucleates the heat storage material in the supercooled state.

Various embodiments will be described hereinafter with reference to the accompanying drawings.

### First Embodiment

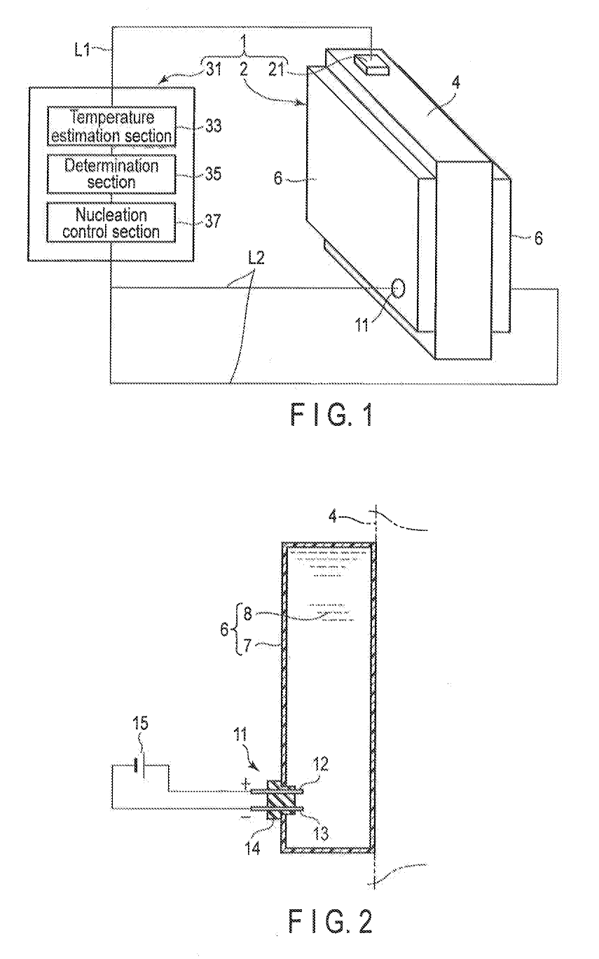

A first embodiment will be described below in detail with reference to FIG. 1 to FIG. 4.

As shown in FIG. 1, a power supply apparatus 1 comprises a battery module 2, a temperature sensor 21, and a controller 31.

The battery module 2 comprises a secondary battery 4, a heat storage pack 6, and a nucleation mechanism 11. The battery module 2 is housed in a casing (not shown in the drawings) used to protect a battery.

The secondary battery 4 is a single battery comprising, for example, a lithium ion battery. The secondary battery 4 is shaped like a relatively flat rectangular cuboid.

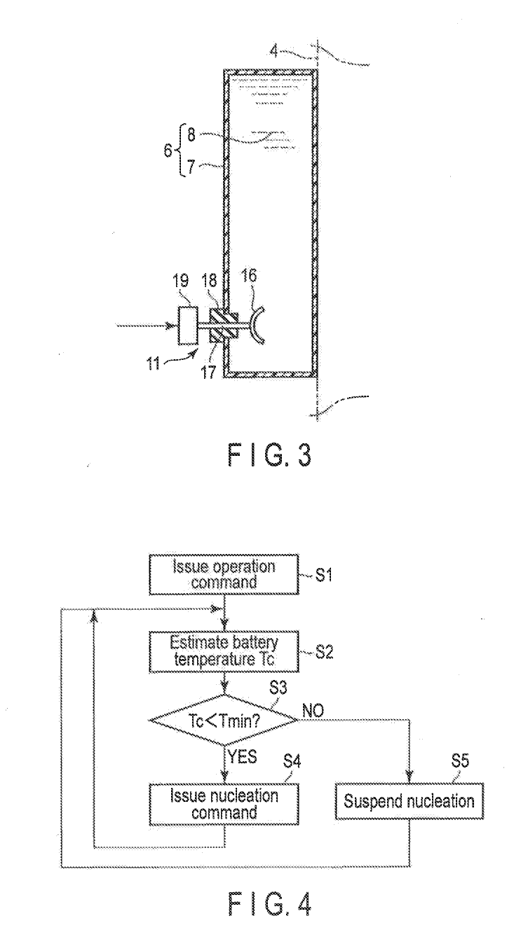

As shown in FIG. 2 or FIG. 3, the heat storage pack 6 comprises a container 7 and a heat storage material 8 sealed in the container 7.

The container 7 is a closed container. The container 7 is, for example, thinner and smaller than the secondary battery 4. The container 7 is formed of, for example, a synthetic resin or metal. However, the container 7 is not limited to this material and may be formed of a laminate film.

The container 7 is preferably formed of a material with thermal conductivity that exceeds that of a material providing the contour of the secondary battery 4.

Moreover, the material of the container 7 is preferably thinner than the material providing the contour of the secondary battery 4.

The heat storage material 8 is housed in the container 7. As the heat storage material 8, a latent heat storage material (PCM; Phase Change Material) is used which may be set to a supercooled state. The heat storage material 8 is referred to as a phase change heat storage material.

The heat storage material 8 absorbs heat upon being melted to change from a solid to a liquid at the melting point of the heat storage material 8. In contrast, the heat storage material 8 releases heat upon being solidified to change from a liquid to a solid. Moreover, the heat storage material 8 in the liquid state resulting from the melting is characterized by maintaining a liquid state without being solidified even when the temperature of the heat storage material 8 becomes equal to or lower than the melting point. This characteristic is known as a supercooling characteristic.

Examples of the heat storage material 8 include a sodium acetate hydrate and a sodium thiosulfate hydrate.

The sodium acetate hydrate and the sodium thiosulfate hydrate are characterized by being able to stably maintain a supercooled state even when each of the hydrates in its liquid state resulting from melting is cooled closer to its freezing point.

The heat storage material 8 is arranged in contact with at least one of the opposite side surfaces of the secondary battery 4 in the thickness direction thereof. Thus, the heat storage pack 6 and the secondary battery 4 are combined together in a configuration in which the heat storage pack 6 and the secondary battery 4 are in thermal contact with each other. The configuration in which the heat storage material 8 and the secondary battery 4 are in thermal contact with each other refers to a configuration in which the heat storage material 8 and the secondary battery 4 can exchange heat with each other.

Specifically, in the first embodiment, the heat storage pack 6 is arranged such that the container 7 is in direct contact with the side surface of the secondary battery 4 in the thickness direction thereof. In other words, the heat storage pack 6 and the secondary battery 4 are combined together such that the heat storage pack 6 is laid upon the side surface of the secondary battery 4. Moreover, in other words, the heat storage pack 6 and the secondary battery 4 are combined together after the heat storage pack 6 is applied to the side surface of the secondary battery 4.

The heat storage pack 6 may be arranged such that a heat transfer member is sandwiched between the side surface of the secondary battery 4 and the container 7. As the heat transfer member, for example, a heat transfer sheet may be used which has excellent thermal conductivity. In this case, a thin and flexible heat transfer sheet is preferably used.

The nucleation mechanism 11 is attached to each heat storage pack 6. The nucleation mechanism 11 is provided to cancel the supercooled state of the heat storage material 8. The nucleation mechanism 11 generates a crystal nucleus in the heat storage material 8 in its supercooled state to solidify the heat storage material 8. Cancelling the supercooled state of the heat storage material 8 to solidify the heat storage material 8 is referred to as “nucleation”. Furthermore, starting nucleation is referred to as “operating the nucleation mechanism 11”.

FIG. 2 shows an aspect of the nucleation mechanism 11.

The nucleation mechanism 11 comprises an electrode 12 providing a positive electrode, electrode 13 providing a negative electrode, an electrode holder 14, and a nucleation power supply 15.

The electrode holder 14 is formed of an electric insulator and attached to the container 7 in a liquid-tight manner. The electrodes 12 and 13 penetrate the electrode holder 14 in a liquid-tight manner. The electrodes 12 and 13 are in contact with the heat storage material 8 in the container 7. The nucleation power supply 15 is electrically connected to the electrodes 12 and 13. The nucleation power supply 15 applies a voltage to the electrodes 12 and 13. The application of the voltage is controlled by controller 31 described below.

When the nucleation mechanism 11 shown in FIG. 2 is operated, a voltage is applied to the electrodes 12 and 13 to allow current to flow between the electrodes 12 and 13. The energy of the applied voltage allows the heat storage material 8 in the supercooled state to be nucleated.

FIG. 3 shows another aspect of the nucleation mechanism ii. The nucleation mechanism 11 comprises a pin 16, a push rod 17, a holder 18, and an actuator 19.

The pin 16 is arranged in the container 7 in contact with the heat storage material 8. The pin 16 is formed of metal and can be deformed when subjected to an external force and restored to its original, non-deformed shape as the external force is lost.

The holder 18 is attached to the container 7 in a liquid-tight manner. The push rod 17 penetrates the holder 18 in a liquid-tight manner. The push rod 17 may be moves in the thickness direction of the holder 18. A tip of the push rod 17 is in contact with the pin 16. The actuator 19 is located outside the heat storage pack 6. The actuator 19 is driven by power supplied to the actuator 19.

The actuator 19 is driven to move the push rod 17 so that the push rod 17 projects into the container 7. When a power supply to the actuator 19 is stopped, the restoration force of the pin 16 allows the push rod 17 to be pushed back to the original position of the push rod 17. The power supply to the actuator 19 and the stop of the power supply are controlled in a timely manner by the controller 31 described below.

When the nucleation mechanism 11 shown in FIG. 3 is operated, the push rod 17 is pushed in to deflect the pin 16. Deflection of the pin 16 provides energy to the heat storage material 8. As a result, the heat storage material 8 in its supercooled state is nucleated.

As shown in FIG. 1, a temperature sensor 21 is attached to the battery module 2. According to the first embodiment, the temperature sensor 21 is arranged in contact with an outer surface of a contour of the secondary battery 4.

The temperature sensor 21 may be arranged inside the secondary battery 4, for example, in contact with an inner surface of the contour of the secondary battery 4. Alternatively, the temperature sensor 21 may be arranged in contact with the portion thermally connected to the secondary battery 4, in other words, an outer surface of the container 7.

The controller 31 shown in FIG. 1 is located outside the battery module 2. The controller 31 is formed using a microcomputer. Various data needed to allow the secondary battery 4 to be used within an appropriate temperature range (guaranteed temperature range) are stored in a memory (not shown in the drawings) provided in the controller 31.

The controller 31 is not limited to a dedicated controller for the battery module 2 and may be connected to or incorporated in another control system. An example of another control system may be a control system for an electric apparatus which is operated using the battery module 2 as a power supply or a network home appliance control system that controls the electric apparatus and other home appliance products.

As shown in FIG. 1, the controller 31 comprises a temperature estimation section 33, a determination section 35, and a nucleation control section 37.

The temperature sensor 21 and the controller 31 are electrically connected together via an electric wire L1. Thus, a temperature Ta detected by the temperature sensor 21 is input to the temperature estimation section 33. The temperature estimation section 33 is configured to be able to estimate the temperature Tc of the secondary battery 4 based on the input temperature Ta. To distinguish it from other temperatures, the temperature Tc is hereinafter referred to as the estimated temperature Tc.

The determination section 35 has a first threshold preset therein. The first threshold is a lower limit temperature Tmin that is a reference value allowing determination of whether or not to operate the nucleation mechanism 11. The lower limit temperature Tmin is set to a temperature lower than the melting point of the heat storage material 8, for example, the freezing point of the heat storage material 8. The estimated temperature Tc is input to the determination section 35. The determination section 35 compares the lower limit temperature Tmin, the lower limit value of the guaranteed temperature range, with the estimated temperature Tc.

The nucleation control section 37 and the nucleation mechanism 11 are electrically connected together via an electric wire L2. A determination result from the determination section 35 is input to the nucleation control section 37. In accordance with the input determination result, the nucleation mechanism 11 is operated, or the operation of the nucleation mechanism 11 is suspended.

While in operation (that is, while being charged and while being discharged), the secondary battery 4 of the battery module 2 generates and releases heat to the surroundings. Accordingly, heat (exhaust heat) transferred to the heat storage pack 6 raises the temperature of the heat storage material 8. Thus, when in a solid state, the heat storage material 8 changes into a liquid at the melting point of the heat storage material 8. Accordingly, the exhaust heat is stored in the heat storage material 8 as latent heat (hereinafter referred to as melting latent heat).

In this state, when the secondary battery 4 stops operating and is left uncontrolled, the heat in the heat storage material 8 is released to the surroundings. In the low temperature environment, the temperature of the heat storage material 8 may be lower than the freezing point. Even when the temperature of the heat storage material 8 is lower than the freezing point, the heat storage material 8 maintains its liquid state due to its supercooling characteristic. That is, the heat storage material 8 maintains a supercooled state.

Thus, when the nucleation mechanism 11 is operated under the control of the controller 31 to nucleate the heat storage material 8, which is already in the supercooled state, the heat storage material 8 is solidified. At this time, the heat storage material 8 releases the latent heat (hereinafter referred to as the solidification latent heat). The solidification latent heat is transferred to the secondary battery 4, which is thus heated.

Next, a procedure for operating the power supply apparatus 1 will be described with reference to FIG. 4.

First, in step S1, a command to operate the secondary battery 4 of the battery module 2 is provided to the controller 31.

The timings for executing the “operation command” in step S1 are a timing when charging is started, and a timing when discharging is started during a period when charging and discharging of the secondary battery 4 of the battery module 2 is repeated at a preset current value or greater.

Three usage examples will be specifically separately described below: a usage example (first usage example) in which the power supply apparatus 1 according to the first embodiment is applied as an in-vehicle power supply mounted in an electric car; a usage example (second usage example) in which the power supply apparatus 1 according to the first embodiment is applied as a home electricity storage apparatus that stores supplied power; and a usage example (third usage example) in which the power supply apparatus 1 according to the first embodiment is applied as a power supply for an electronic apparatus such as a personal computer.

In the first usage example, the “operation command” is issued during a period (discharge period) from turn-on of a start switch of the electric car until the start switch is turned off and a period when the electric car is charged while stopped. In other words, the “operation command” is executed at a timing when the start switch is turned on. Similarly, the “operation command” is executed at a timing when charging is started.

Alternatively, the timing for executing the “operation command” may be set to be a point of time when discharging is started, and a point of time before charging is started. For example, if a switch that detects a driver's presence is installed in the vehicle, the “operation command” may be executed at a timing when the switch is turned on.

The power supply apparatus in the second usage example is a battery installed at a predetermined location in a residence and is generally referred to as a stationary battery. The battery is used as a battery in which power generated by a solar cell or a fuel cell is stored. Alternatively, the battery is used as a battery in which power supplied via a power grid is stored at midnight.

When the battery is used to store, for example, power from a solar cell, the “operation command” is issued during midday hours when the solar cell is irradiated with sunlight. In other words, the “operation command” is executed at a timing when charging is started using supplied power generated by the solar cell.

In the third usage example, the “operation command” is issued during a period (discharge period) from turn-on of a power switch of the electronic apparatus until the power switch is turned off and a period when the electronic apparatus is discharged. In other words, the “operation command” is executed at a timing when the power switch is turned on. Similarly, the “operation command” is executed at a timing when charging is started.

After executing step S1, the controller 31 carries out step S2. In step S2, the temperature Ta of the battery module 2 detected by the temperature sensor 21 is loaded into the temperature estimation section 33. By the temperature estimation section 33, temperature (estimated temperature Tc) of the secondary battery 4 is estimated based on the temperature Ta.

In the next step S3, the controller 31 determines whether or not the estimated temperature Tc is lower than the lower limit temperature Tmin. When the battery module 2 is in the low temperature environment, the estimated temperature Tc of the secondary battery 4 is correspondingly low. When the estimated temperature Tc is lower than the lower limit temperature Tmin, the determination in step S3 is YES.

In a condition where the determination in step S3 is YES, the temperature of the heat storage material 8 is lower than the lower limit temperature Tmin. That is, the temperature of the heat storage material 8 is lower than the melting point of the heat storage material 8. Thus, the heat storage material 8, which has been changed into a liquid due to heat released by the secondary battery 4, is in the supercooled state.

When the determination in step S3 is YES, the controller 31 executes step S4 to allow the nucleation control section 37 to operate the nucleation mechanism 11. Thus, the heat storage material 8 is nucleated and solidified.

Therefore, the secondary battery 4 having contacted the heat storage pack 6 is heated by the solidification latent heat released by the heat storage material 8. In other words, the latent heat released by the heat storage material 8 is provided to the secondary battery 4 via the container 7 to raise the temperature of the secondary battery 4. This improves the ability of the secondary battery 4 to start at low temperature.

On the other hand, when the battery module 2 is in the high temperature environment, the estimated temperature Tc of the secondary battery 4 is correspondingly high. Thus, when the estimated temperature Tc is equal to or higher than the lower limit temperature Tmin, the determination in step S3 is NO. In a condition where the determination in step S3 is NO, the temperature of the heat storage material 8 is equal to or higher than the lower limit temperature Tmin. That is, the temperature of the heat storage material 8 is higher than the melting point of the heat storage material 8, and the heat storage material 8 is liquid.

When the determination in step S3 is NO, step S5 is executed. In this case, the nucleation control section 37 suspends operation of the nucleation mechanism 11. Thus, the solidification latent heat in the heat storage material 8 is not released. This prevents unwanted heat from the heat storage material 8 from being provided to the secondary battery 4 at a high temperature.

As described above, when the temperature of the secondary battery 4 is estimated to be lower than the lower limit temperature Tmin, the heat storage material 8 in the supercooled state is nucleated. Consequently, the secondary battery 4 can be heated utilizing the solidification latent heat released by the heat storage material 8.

On the other hand, when the temperature of the secondary battery 4 is estimated to be equal to or higher than the lower limit temperature Tmin, the operation of the nucleation mechanism 11 is suspended. This prevents the secondary battery 4 from being unnecessarily heated, and the secondary battery 4 is controlled to preclude an excessive rise in the temperature of the secondary battery 4. This in turn prevents the durability of the secondary battery 4 from decreasing, allowing degradation in the reliability of the secondary battery 4 to be controlled.

That is, the power supply apparatus 1 according to the first embodiment uses the heat storage material 8 characterized by its supercooling capability and allows the controller 31 to control the operation of the nucleation mechanism 11, which nucleates the heat storage material 8, in accordance with the temperature of the secondary battery 4.

Thus, active control can be performed in which the heat storage material 8 in the supercooled state is nucleated to heat the secondary battery 4 and in which the nucleation is suspended to refrain from heating of the secondary battery 4. This eliminates the need to provide the heat storage material 8 with heat insulation means for preventing the latent heat stored in the heat storage material 8 from being released to the surroundings of the heat storage material 8 in the low temperature environment. The temperature of the heat storage material 8 can correspondingly be controlled from increasing excessively in the high temperature environment.

Therefore, the first embodiment can provide the battery module 2 and the power supply apparatus 1 a means which improves the battery's ability to start in the low temperature environment and which enables the reliability of the battery to be controlled from degrading as a result of an excessive rise in battery temperature in the high temperature environment.

Moreover, in the power supply apparatus 1 according to the first embodiment, the heat storage pack 6 of a sealed structure is arranged in contact with the side surface of the secondary battery 4. Thus, during charging of the secondary battery 4 and during discharging of the secondary battery 4, heat released by the secondary battery 4 can be absorbed directly by the heat storage material 8. Similarly, the secondary battery 4 can be heated directly by latent heat released by the heat storage material 8 when the heat storage material 8 is nucleated. The heat storage material 8 and the secondary battery 4 exchange heat directly with each other, improving heat exchange performance.

Furthermore, the power supply apparatus 1 according to the first embodiment eliminates the need for circulation components such as a pump and a pipe which allow the heat storage material 8 to circulate in its liquid state. Thus, the power supply apparatus 1 has a simple configuration and can be configured to be small in size.

An attempt to circulate the heat storage material 8 in the supercooled state may cause the heat storage material 8 to be crystallized by the resultant energy. Thus, the heat storage material 8 can be circulated by filling the heat storage material into a capsule and dispersing the capsule in a liquid solution. However, this reduces the amount of latent heat stored in the heat storage material. Therefore, the circulation is disadvantageous in connection both with absorption of the heat in the secondary battery 4 and with release of the latent heat in the heat storage material to the secondary battery 4.

### Second Embodiment

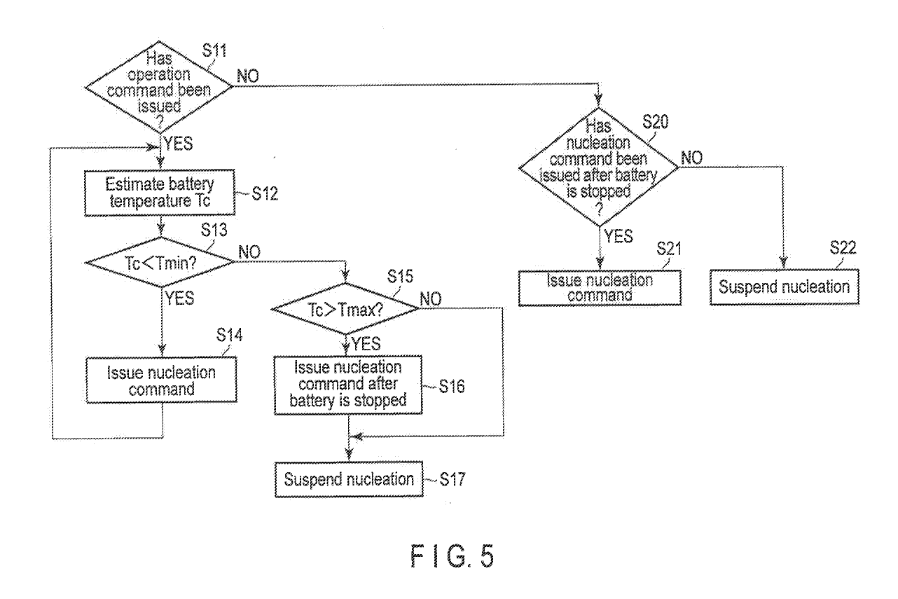

FIG. 5 is a flowchart illustrating a procedure for operating a power supply apparatus 1 according to a second embodiment. The power supply apparatus 1 according to the second embodiment is the same as the power supply apparatus 1 according to the first embodiment except for the procedure for operation. In other words, the power supply apparatus 1 according to the second embodiment has the same structure as that of the power supply apparatus 1 according to the first embodiment. Thus, the power supply apparatus 1 according to the second embodiment will be described with reference to FIG. 1 and other figures as necessary.

The procedure for operating the power supply apparatus 1 according to the second embodiment will be described with reference to FIG. 5.

First, step S11 determines whether or not the “operation command” allowing a secondary battery 4 to operate has been issued. The timing of when the “operation command” is issued is as described in the first embodiment.

If the operation command for the secondary battery 4 has been issued, the determination in step S11 is YES. Then, step S12 is executed. Subsequently, a determination is made in step S23, and when the determination in step S13 is YES, step S14 is executed.

Steps S12 to S14 correspond to steps S2 to S4 described in the first embodiment.

Thus, when step S11 determines that the “operation command” allowing a secondary battery 4 to operate has been issued, the temperature Tc of the secondary battery 4 is estimated from the temperature Ta of a battery module 2 detected by a temperature sensor 21 (step S12). When the next step S13 determines that the estimated temperature Tc is lower than a preset lower limit temperature Tmin, a heat storage material 8 in the supercooled state is nucleated when step S14 is executed.

As described above, in the temperature management performed by the system in steps S11 to S14, the heat storage material 8 is nucleated when the secondary battery 4 of the battery module 2 is in operation (the secondary battery 4 is being charged or discharged) and when the estimated temperature Tc of the secondary battery 4 is lower than the lower limit temperature Tmin. This allows the secondary battery 4 to be heated by solidification latent heat released by the heat storage material 8.

When the determination in step S13 is NO (in other words, the estimated temperature Tc is higher than the lower limit temperature Tmin), a determination is made in step S15.

Step S15 determines whether or not the estimated temperature Tc is higher than a preset second threshold (in other words, an upper limit temperature Tmax that is the upper limit value of the guaranteed temperature range of the secondary battery). The upper limit temperature Tmax is set higher than the melting point of the heat storage material 8.

When the estimated temperature Tc is higher than the upper limit temperature Tmax, the determination in step S15 is YES. In this case, the next step S16 is executed. In step S16, a command to place the nucleation in stand-by is generated and stored in the memory in the controller 31. The command allows the heat storage material 8 to be nucleated after the secondary battery 4 stops operating.

Accordingly, a nucleation control section 37 suspends the operation of the nucleation mechanism 11 (step S17). This prevents unwanted heat from the heat storage material 8 from being supplied to the secondary battery 4.

As described above, in the temperature management performed by the system in steps 11 to 13 and in steps 15 to 17, the nucleation of the heat storage material 8 is suspended with the command to place the nucleation in standby is saved, when the secondary battery 4 of the battery module 2 is in operation (the secondary battery 4 is being charged or discharged), and when the estimated temperature Tc of the secondary battery 4 exceeds the upper limit temperature Tmax. This prevents the secondary battery 4 in operation from being heated by the solidification latent heat in the heat storage material 8. Therefore, the temperature of the secondary battery 4 in operation is not excessively raised.

On the other hand, when the estimated temperature Tc is higher than the lower limit temperature Tmin and lower than the upper limit temperature Tmax, the determination in step S15 is NO. In this case, step S17 is carried out without the execution of step S16.

Therefore, in the temperature management performed by the system in steps 11 to 13, step 15, and step 17, the nucleation of the heat storage material 8 is suspended when the secondary battery 4 of the battery module 2 is in operation (the secondary battery 4 is being charged or discharged), and when the estimated temperature Tc of the secondary battery 4 is between the lower limit temperature Tmin and the upper limit temperature Tmax. This prevents the secondary battery 4 in operation from being heated by the solidification latent heat in the heat storage material 8. Therefore, the temperature of the secondary battery 4 is not excessively raised.

When the operation of the battery module 2 (to be exact, charging or discharging of the secondary battery 4) is stopped, the determination in step 11 is NO. Then, controller 31 determines in step S20 whether or not the command to place the nucleation in stand-by is stored in the memory.

If the operation of the secondary battery 4 is stopped after the above-described step S16 is executed, the determination in step S20 is YES. In response, the next step S21 is executed. In step S21, nucleation mechanism 11 is operated to execute a process of nucleating the heat storage material 8. Thus, the secondary battery 4 is heated by the solidification latent heat released by the heat storage material 8.

In this stage, the secondary battery 4 is stopped and is generating no heat, the temperature of the secondary battery 4 is controlled from rising even when the secondary battery 4 is heated. If the battery module 2 is implemented as an in-vehicle power supply apparatus, low-temperature cooling air from the outside may be blown against the battery module 2 while the battery module 2 is stopped, to release the heat in the battery module 2 in a short time.

With the temperature management performed by the system in steps S11 to S13 and steps S15 to S17, the temperature of the secondary battery 4 of the battery module 2 exceeds an upper limit temperature Tmax. Thus, when the secondary battery 4 is further heated, the reliability of the secondary battery 4 may be degraded.

The heat storage material 8 of the heat storage pack 6 in contact with the secondary battery 4 absorbs a large amount of heat in the secondary battery 4 as melting latent heat. When the temperature of the heat storage material 8 exceeds the melting point of the heat storage material 8 due to the absorbed heat, the heat storage material 8 is melted. However, the melting of the heat storage material 8 ends when the temperature exceeds the melting point. Therefore, further absorption of melting latent heat is impossible. On the other hand, the melted heat storage material 8 changes to the supercooled state due to a decrease in temperature after the operation of the secondary battery 4 is stopped. The heat storage material 8 keeps the melting latent heat stored therein. Thus, unless the stored latent heat is released, the heat storage material 8 fails to absorb the heat in the secondary battery 4 the next time the secondary battery 4 is operated.

However, as described above, the latent heat in the heat storage material 8 is forcibly released while the secondary battery 4 is stopped, as a result of the temperature management performed by the system in step S11, step S20, and step S21. This allows the heat storage material 8 to remain solidified. That is, the heat storage material 8 is reset to be able to perform heat absorption utilizing solidification latent heat.

Therefore, when the secondary battery 4 of the battery module 2 is subsequently operated, the heat storage material 8 can absorb heat again which is released by the secondary battery 4.

If step S16 fails to be executed to cause the secondary battery 4 to stop operating, the determination in step S20 is NO. In response, step S22 is executed in which the operation of the nucleation mechanism 11 is suspended. This prevents unwanted heat from the heat storage material 8 from being released to the secondary battery 4.

The second embodiment can also provide the battery module 2, the power supply apparatus 1 with the module, and a method for managing the battery module 2, all of which improves the battery's ability to start in the low temperature environment, and which enables the reliability of the battery to be controlled from degrading as a result of an excessive rise in battery temperature in the high temperature environment.

### Third Embodiment

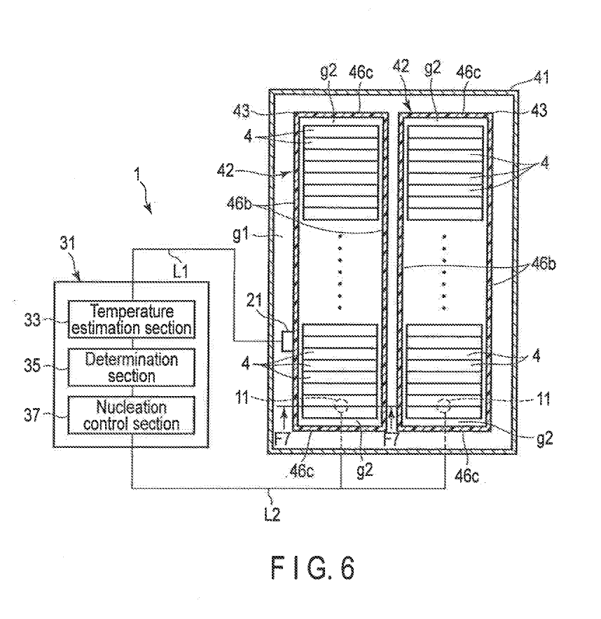

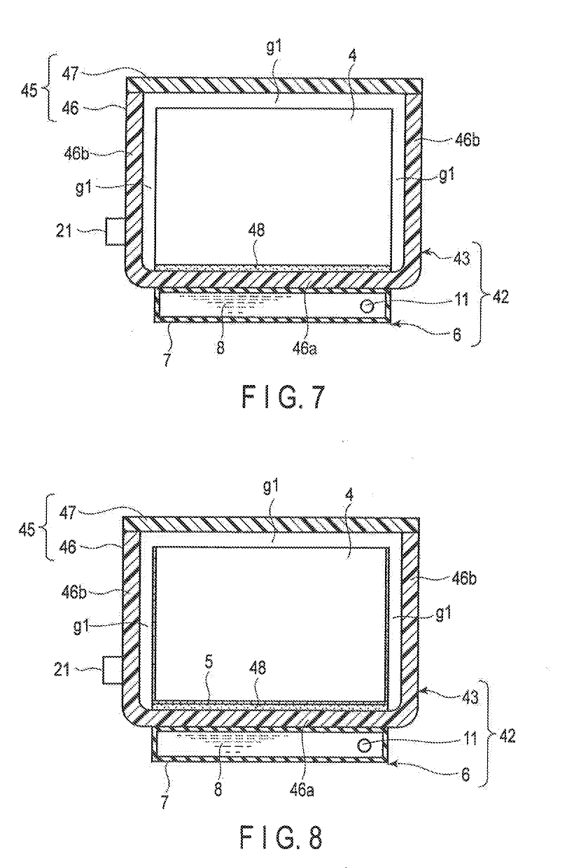

FIG. 6 shows a power supply apparatus 1 according to the third embodiment. FIG. 7 is a cross-sectional view of a battery module 42 as seen along line F7-F7 in FIG. 6. The power supply apparatus 1 according to the third embodiment is the same as the power supply apparatus 1 according to the first embodiment except that the battery module 42 is configured differently from the battery module 2. Thus, components of the third embodiment which have functions identical or similar to the corresponding functions of the first embodiment are denoted by the same reference numerals as those in the first embodiment and will not be described.

As shown in FIG. 6, the power supply apparatus 1 according to the third embodiment comprises a casing 41, the battery module 42, a temperature sensor 21, and a controller 31. The controller 31 is located outside the casing 41. The controller 31 is configured as described in the first embodiment.

At least one, or for example a plurality of, and specifically two battery modules 42 are provided. The battery modules 42 are arranged side by side in the casing 41.

Each of the battery modules 42 comprises a battery pack 43, heat storage pack 6, and nucleation mechanism 11.

Each of the battery packs 43 comprises a battery container 45 and a plurality of secondary batteries 4.

As shown in FIG. 7, the battery container 45 comprises a container main body 46 and a cover 47. The battery container 45 is shaped generally like a rectangular cuboid. The container main body 46 and the cover 47 are formed of a synthetic resin or metal such as stainless steel.

The container main body 46 comprises a rectangular bottom wall 46a (see FIG. 7), sidewalls 46a, and end walls 46c (see FIG. 6). The side walls 46b are integrally continuous with the respective opposite side edges of the bottom wall 46a. The end walls 46c are integrally continuous with the respective longitudinally opposite edges of the bottom wall 46a. The end walls 46c are also integrally continuous with the respective longitudinally opposite edges of the side wall 46b and each span the sidewall 46b.

The cover 47 is attached to the container main body 46 so as to close an upper end opening of the container main body 46.

The plurality of secondary batteries 4 is housed in the battery container 45. As shown in FIG. 6, the secondary batteries 4 are aggregated together so as to lie side by side in the battery container 45. In other words, the secondary batteries 4 are housed and arranged in the battery container 45 so as to be aggregated together in such a manner as to be stacked in the direction of arrangement of the secondary batteries 4.

Each of the secondary batteries 4 is arranged so as to stand orthogonally to the bottom wall 46a of the container main body 46. Each of the secondary batteries 4 is fixed with an adhesive 48 (see FIG. 7) to a wall portion of the container main body 46 and preferably to the bottom wall 46a, positioned in the direction of gravity.

To absorb a change in the volume of the secondary battery 4 as a result of expansion and contraction of the secondary battery 4, each secondary battery 4 is fixed in contact only with the bottom wall 46a. That is, a gap g1 (see FIG. 7) is provided between each secondary battery 4 and the sidewall 46b and between the secondary battery 4 and the cover 47. Furthermore, a gap g2 (see FIG. 6) is provided between the end wall 46c and the secondary battery 4 positioned at each of the opposite ends of the arrangement of the secondary batteries 4. Moreover, a gap of approximately 1 mm to 2 mm (not shown in the drawings) is present between the adjacent secondary batteries 4 in the longitudinal direction of the battery container 45.

A heat storage pack 6 and nucleation mechanism 11 are configured similarly to the heat storage pack 6 and the nucleation mechanism 11 both described in the first embodiment.

As shown in FIG. 7, the heat storage pack 6 is arranged in contact with the wall portion of the battery container 45, to which each secondary battery 4 is fixed, in other words, in contact with an outer surface of the bottom wall portion 46a. The heat storage pack 6 is substantially as large as the bottom wall portion 46a. The heat storage pack 6 extends in a longitudinal direction of the battery container 45 to cover substantially the entire surface of the bottom wall 46a.

Thus, each secondary battery 4 in the battery container 45 and the heat storage pack 6 located outside the battery container 45 are in tight contact with each other via the bottom wall portion 46a without any gap. Accordingly, the secondary battery 4 and the heat storage pack 6 are arranged so as to be thermally connected tighter via the bottom wall 46a. In other words, the secondary battery 4 and the heat storage pack 6 are arranged so as to be able to exchange heat based on heat transfer.

The controller 31 simultaneously provides control output for operation of each nucleation mechanism 11 to all of the nucleation mechanism 11.

The temperature sensor 21 may be attached to one of the battery modules 2, for example, the battery module 2 positioned in the left of FIG. 6. Specifically, the temperature sensor 21 is arranged in contact with an outer surface of the battery container 45, for example, a lower outer surface of the sidewall 46b (see FIG. 7). Alternatively, the temperature sensor 21 may be arranged in contact with an outer surface of the end wall 46c or the cover 47 or in contact with an inner surface of the battery container 45.

In the third embodiment, the plurality of secondary batteries 4 provided in the battery module 42 generates heat while in operation (in other words, while being charged and while being discharged). The heat is transferred to the heat storage pack 6 via an adhesive 48 and the bottom wall 46a of the battery container 45.

In this case, the adhesive 48 and the bottom wall 46a are factors that increase thermal resistance. However, no heat transfer paths other than the above-described heat transfer paths are present. Thus, regardless of whether or not the thermal resistance is present, the heat in the secondary battery 4 can be transferred to the heat storage pack 6 in a concentrated manner, and solidification latent heat released by the heat storage material 8 can be transferred to each of the secondary batteries 4 in a concentrated manner.

The heat (exhaust heat) in the secondary battery 4 transferred to the heat storage pack 6 raises the temperature of the heat storage material 8 in the heat storage pack 6. Thus, when the heat storage material 8 is in its solid state, the heat storage material 8 is melted into a liquid at the melting point of the heat storage material 8. The exhaust heat is correspondingly stored in the heat storage material 8 as melting latent heat.

In this state, when each secondary battery 4 stops operating and is then left uncontrolled, the heat in the heat storage material 8 is released to the surroundings. Thus, in the low temperature environment, the temperatures of each secondary battery 4 and the heat storage material 8 may lower close to the freezing point of the heat storage material 8. In this case, the heat storage material 8 maintains its liquid state due to its characteristics. In other words, the heat storage material 8 is kept in the supercooled state. The supercooled heat storage material 8 stores the melting latent heat.

In this state, when the nucleation control section 37 operates the nucleation mechanism 11 based on control performed by the controller 31, the heat storage material 8, which is already in the supercooled state, is nucleated. Thus, the heat storage material 8 is solidified, and at this time, the heat storage material 8 releases the solidification latent heat. The solidification latent heat is transferred to the secondary batteries 4 via the bottom wall 46a of the battery container 45 and the adhesive 48. The secondary batteries 4 are thus heated.

A procedure in which the power supply apparatus 1 according to the third embodiment is operated by the controller 31 is as described above in the first embodiment with reference to FIG. 4. The power supply apparatus according to the third embodiment may be operated in accordance with the procedure described in the second embodiment with reference to FIG. 5.

The third embodiment, including the components omitted from FIG. 6 and FIG. 7, is the same as the first embodiment except for the features described above. Thus, the third embodiment also improves the battery's ability to start in the low temperature environment and enables the reliability of the battery to be controlled from degrading as a result of an excessive rise in battery temperature in the high temperature environment.

As described above, the battery module 42 according to the third embodiment comprises the plurality of aggregated secondary batteries 4. Thus, the third embodiment can increase the battery output from the battery module 42 above the battery output from the battery module according to the first embodiment.

Moreover, the heat storage pack 6 is independent of and separate from the plurality of secondary batteries 4. Thus, when aggregated together so as to lie side by side, the secondary batteries 4 can be densely aggregated together without being affected by an arrangement space for the heat storage pack 6. This allows the battery module 2 to be miniaturized. In contrast, when battery modules are arranged side by side so as to provide as many secondary batteries as the secondary batteries used according to the third embodiment, the space in which the heat storage pack is arranged needs to be provided between the adjacent secondary batteries. Consequently, the resultant battery module is increased in size in the arrangement direction of the secondary batteries.

Furthermore, in the battery module 42 according to the third embodiment, the heat storage pack 6 is located outside the battery pack 43. Additionally, in the battery pack 43, each secondary battery 4 and the heat storage pack 6 are separated from each other via the battery container 45 serving as a partition wall. This ensures the safety of each secondary battery 4 with respect to the heat storage material 8.

Thus, if the container 7 of the heat storage pack 6 is damaged, the heat storage material 8 in the container 7 leaks from the container 7. However, the battery container 45 prevents the leaking heat storage material 8 from reaching the secondary battery 4. Thus, the secondary battery 4 avoids being short-circuited. This further prevents a reaction between the leaking heat storage material 8 and the internal material of the secondary battery 4 which may be caused by short-circuiting.

### Fourth Embodiment

FIG. 8 shows the structure of an important part of a power supply apparatus 1 according to a fourth embodiment. The fourth embodiment is the same as the third embodiment except for the configuration of a battery module. Thus, components of the fourth embodiment which have functions identical or similar to the corresponding functions of the third embodiment are denoted by the same reference numerals as those in the third embodiment and will not be described. The following description will also be given with reference to FIG. 6 as necessary.

In the fourth embodiment, a thermal conducting sheet 5 with a high thermal conductivity is provided on an outer surface of each of a plurality of secondary batteries 4 in a battery module 42. Specifically, as shown in FIG. 8, the thermal conducting sheet 5 is integrally continuous so as to span a side surface of the secondary battery 4 spaced from a sidewall portion 46b of a container main body 46 via a gap g1 and a bottom surface of the secondary battery 4. With the thermal conducting sheet 5 attached to the bottom surface of the secondary battery 4 in contact with the adhesive 48, the secondary battery 4 is fixed to a bottom wall portion 46a of the container main body 46 with the adhesive 48.

The plurality of secondary batteries 4 in the battery module 42 generates heat while in operation (that is, while being charged and while being discharged). The heat is transferred to a heat storage pack 6 via the adhesive 48 and the bottom wall portion 46a of a battery container 45. In this case, heat released though the side surface of the secondary battery 4 is transferred via the thermal conducting sheet 5 to an intermediate area of a part of the thermal conducting sheet 5 which is in contact with the adhesive 48. This improves the radiation of heat from the secondary battery 4 to the bottom wall portion 46a of the battery container 45, allowing the heat in the secondary battery 4 to be transferred to the heat storage pack 6 in a concentrated manner. Furthermore, in contrast, when solidification latent heat is released, the released solidification latent heat can be transferred to each secondary battery 4 not only through the bottom surface but also through the side surfaces of the secondary battery 4.

The components of the fourth embodiment not shown in FIG. 8 are the same as the corresponding components of the third embodiment except for the above description. Therefore, the fourth embodiment also improves the battery's ability to start in the low temperature environment and enables the reliability of the battery to be controlled from degrading as a result of an excessive rise in battery temperature in the high temperature environment.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

1. A battery module comprising:
a secondary battery;
a heat storage pack comprising a heat storage material that is able to be set to a supercooled state, the heat storage pack being arranged in contact with the secondary battery to exchange heat with the secondary battery; and
a nucleation mechanism attached to the heat storage pack to nucleate the heat storage material in the supercooled state.

2. A battery module comprising:
a battery pack comprising a plurality of aggregated secondary batteries;
a heat storage pack comprising a heat storage material that is able to be set to a supercooled state, the heat storage pack being arranged in contact with the battery pack to exchange heat with the secondary batteries; and
a nucleation mechanism attached to the heat storage pack to nucleate the heat storage material in the supercooled state.

3. The battery module of claim 2, wherein the battery pack comprises a battery container in which the secondary batteries are housed, and the heat storage pack is arranged in contact with an outer surface of a wall portion of the battery container to which the secondary batteries are fixed.

4. A power supply apparatus comprising:
the battery module according to any one of claims 1 to 3;
a temperature sensor attached to the battery module; and
a controller comprising a temperature estimation section configured to estimate a temperature of the secondary battery based on a temperature detected by the temperature sensor when the secondary battery starts charging or discharging, a determination section configured to compare the estimated temperature with a lower limit temperature within a guaranteed temperature range, and a nucleation control section configured to operate the nucleation mechanism provided in the battery module to nucleate the heat storage material when the estimated temperature is lower than the lower limit temperature and to suspend operation of the nucleation mechanism when the estimated temperature is equal to or higher than the lower limit temperature.

5. The power supply apparatus of claim 4, wherein, when the estimated temperature is higher than an upper limit temperature within the guaranteed temperature range, the controller suspends nucleation of the heat storage material, and after the secondary battery stops charging or discharging, nucleates the heat storage material with the nucleation suspended to reset the secondary battery.

6. A method for managing a temperature of the secondary battery provided in the battery module of claim 1 when the secondary battery starts charging or discharging, the method comprising:
detecting the temperature of the secondary battery via a temperature sensor to estimate the temperature of the secondary battery;
comparing the estimated temperature with a lower limit temperature within a guaranteed temperature range; and
operating the nucleation mechanism provided in the battery module to nucleate the heat storage material when the estimated temperature is lower than the lower limit temperature and suspending operation of the nucleation mechanism when the estimated temperature is equal to or higher than the lower limit temperature.

7. The method for managing the temperature of the secondary battery of claim 6, wherein, when the estimated temperature is higher than an upper limit temperature within the guaranteed temperature range, nucleation of the heat storage material is suspended, and after the secondary battery stops charging or discharging, the heat storage material with the nucleation suspended is nucleated to reset the secondary battery.
